(19) United States
(12) Patent Application Publication
(10) Pub. No.: US 2014/0260540 A1
(43) Pub. Date: Sep. 18, 2014

(54) SAMPLE INLET WITH MULTI-CAPILLARY LINER FOR GAS CHROMATOGRAPHY

(71) Applicant: AGILENT TECHNOLOGIES, INC., Loveland, CO (US)

(72) Inventors: Gregory G. O'Neil, Loveland, CO (US); Harry F. Prest, Loveland, CO (US); Robert V. Mustacich, Loveland, CO (US)

(73) Assignee: Agilent Technologies, Inc., Loveland, CO (US)

(21) Appl. No.: 13/841,815

(22) Filed: Mar. 15, 2013

(51) Int. Cl. G01N 1/22; G01N 30/00

(52) U.S. Cl. CPC G01N 1/22; G01N 30/00
USPC 73/23.42

(57) ABSTRACT

A gas chromatograph (GC) inlet device includes a multi-capillary liner capable of separating components of a sample matrix prior to injecting the sample into an analytical GC column. The device is switchable between different modes, such as a normal injection modes, splitless modes, split modes, a backflush modes, and cut modes.

### TECHNICAL FIELD

The present invention relates generally to gas chromatography (GC), and more particularly sample inlets utilized with GC instruments.

### BACKGROUND

Gas chromatography (GC) entails the analytical separation of a vaporized or gas-phase sample that is injected into a chromatographic column. The column is typically housed in a thermally controlled oven. A chemically inert carrier gas, such as helium, nitrogen, argon, or hydrogen, is utilized as the mobile phase for elution of the analyte sample in the column. The sample and carrier gas are separately introduced into a GC inlet coupled to the column head. In the GC inlet, the sample is injected into the carrier gas stream and the resulting sample-carrier gas mixture flows through the column. The typical GC inlet is configured for vaporizing an initially liquid-phase sample, and may provide a liner configured for performing pre-column separation as well. During column flow the sample encounters a stationary phase (a coating or packing), which causes different components of the sample to separate according to different affinities with the stationary phase. The separated components elute from the column exit and are measured by a detector, producing data from which a chromatogram or spectrum identifying the components may be constructed.

The typical GC inlet is configured for vaporizing an initially liquid-phase sample, and may provide a liner configured for performing pre-column separation as well. The performance of the GC inlet is recognized as playing a key role in the overall performance of a GC-based instrument, including hybrid instruments such as a gas chromatograph-mass spectrometer (GC-MS). While GC inlets have evolved over the years, their designs have largely remained optimized around a temperature controlled chamber with electronically controlled flows and which contains a liner of sufficient volume and chemical inertness for expansion of a small liquid injection. The circumstances surrounding the transfer of vapors from this sample volume in the liner to a GC column govern issues such as, for example, resolution, detection limits, sample discrimination, and sample carryover.

There has long been interest in the selective discrimination between wanted and unwanted components in a GC sample. The typical ideal target would be transferring 100% of the analytes of interest to the GC column and transferring 0% of unwanted components such as heavy, poorly volatile components (often referred to as “background” or “matrix”) and likely the sample's solvent as well. Heavy, poorly volatile components can foul the GC column and downstream components, as well as the liner itself. Solvents can be a burden to the stationary phase of the GC column, overload or mask the separation of analytes, and also damage detection components. The transfer of matrix can be especially problematic for expensive components such as low thermal mass (LTM) GC columns, which are only marginally amenable to column “cut-back” to remove a contaminated column end at the inlet. Moreover, mass spectrometers can slowly accumulate heavy contaminants following transfer of matrix to the GC column and temperature programming of the column.

Known GC inlets are capable of temperature programming, but the level of discrimination provided thereby is too crude to be useful as it does not provide a sharp cut-off between analytes of interest and slightly less volatile non-analyte materials. This problem has been addressed to some extent by employing back-flushable pre-columns. However, pre-columns complicate chromatographs and are located in the GC oven, thus adding to the footprint of a GC instrument. Moreover, when employing an LTM GC column, typically a guard column is provided between the low thermal mass GC column and the GC inlet to protect the LTM GC column from contaminants. The guard column is often contained in a small isothermal oven, which increases the footprint of the GC instrument. Hence, the requirement of a pre-column or guard column does not promote the development of smaller, lighter, mobile, and lower power GC instruments.

Efforts have been made to increase discrimination at the GC inlet, including programmed temperature vaporization (PTV), the use of cryogens to extend the temperature range in the GC inlet, and the of sorbent materials in the GC inlet. An example of PTV is disclosed in U.S. Pat. Nos. 5,827,353 and 5,944,877, the entire contents of which are incorporated herein by reference. These patents, which have been commercialized by Apex Technologies, Inc., Independence, Ky., disclose a split/splitless GC inlet with temperature controlling capability, and which includes a liner having no stationary phase, or alternatively having a stationary phase in the form of a packing of beads or a coating on the inside surface of the liner. Evaluation of this GC inlet has revealed that it is capable of only a slight amount of analyte separation.

In view of the foregoing, there is an ongoing need for GC inlets and methods for reducing or eliminating matrix transfer while optimally transferring analytes of interest to a GC column.

### SUMMARY

To address the foregoing problems, in whole or in part, and/or other problems that may have been observed by persons skilled in the art, the present disclosure provides methods, processes, systems, apparatus, instruments, and/or devices, as described by way of example in implementations set forth below.

According to one embodiment, a gas chromatograph (GC) inlet device includes: an inlet chamber; a sample inlet communicating with the inlet chamber; a carrier gas inlet communicating with the inlet chamber; a liner chamber comprising a first end communicating with the inlet chamber and an axially opposing second end; a plurality of parallel capillaries disposed in the liner chamber; an outlet chamber communicating with the second end; and an outlet port communicating with the outlet chamber for coupling with a GC column.

According to another embodiment, a gas chromatograph (GC) includes: the GC inlet device; and a GC column communicating with the outlet port.

According to another embodiment, a gas chromatograph (GC) inlet assembly includes a vaporization device and a GC inlet device. The vaporization device may include: a vaporization chamber; a carrier gas inlet communicating with the vaporization chamber; a heater configured for heating the vaporization chamber; and a first outlet port communicating with the vaporization chamber. The GC inlet device may include: an inlet chamber communicating with the first outlet port; a sample inlet communicating with the inlet chamber; a liner chamber comprising a first end communicating with the inlet chamber and an axially opposing second end; a plurality of parallel capillaries disposed in the liner chamber; an outlet chamber communicating with the second end; and a second outlet port communicating with the outlet chamber for coupling with a GC column.

According to another embodiment, a method for introducing a sample to a gas chromatograph (GC) chamber includes: flowing a sample and a carrier gas through a liner chamber; separating components of the sample by flowing the sample through a plurality of parallel capillaries disposed in the liner chamber; and flowing the sample from the liner chamber to the GC column.

According to another embodiment, a gas chromatograph (GC) inlet device is configured for performing any of the methods disclosed herein.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a gas chromatograph (GC) according to some embodiments.

FIG. 2 is a schematic elevation view of an example of a GC inlet device according to some embodiments.

FIG. 3 is a cross-sectional view of a multi-capillary liner (MCL) according to some embodiments.

FIG. 4A is a schematic elevation view of a GC inlet device, illustrating an example of operating in a normal splitless injection mode according to some embodiments.

FIG. 4B is a schematic elevation view of a GC inlet device, illustrating an example of operating in a normal split injection mode according to some embodiments.

FIG. 4C is a schematic elevation view of a GC inlet device, illustrating an example of operating in a backflush mode according to some embodiments.

FIG. 4D is a schematic elevation view of a GC inlet device, illustrating an example of operating in a cut mode according to some embodiments.

FIGS. 5A to 5D are chromatograms produced from analysis of a test mixture of C₁₂-C₁₉ hydrocarbons utilizing a GC inlet device as described herein.

FIG. 6 is a schematic view of an example of a GC inlet assembly according to some embodiments

### DETAILED DESCRIPTION

In the context of the present disclosure, the term “analyte” refers generally to any sample molecule of interest to a researcher or user of a gas chromatograph (GC)—that is, a molecule on which an analysis is desired such as, for example, a chromatographic or chromatographic/mass spectral analysis. The term “sample” or “sample matrix” refers to any substance known or suspected of containing analytes. The sample may include a combination of analytes and non-analytes. The term “non-analytes” or “non-analytical components” in this context refers to components of the sample for which analysis is not of interest because such components do not have analytical value and/or impair (e.g., interfere with) the analysis of the desired analytes. Non-analytes may generally be any molecules not of interest such as contaminants or impurities. Examples of non-analytes may include, but are not limited to, water, oils, solvents or other media in which the desired analytes may be found, as well as stationary phase material that has bled from a chromatographic column.

As used herein, for convenience the term “gas” encompasses vapors, and gases in which vapors, droplets or particles may be entrained.

FIG. 1 is a schematic view of an example of a gas chromatograph (GC, or GC system) 100 according to some embodiments. The GC 100 may generally include a GC inlet device 104, a GC column (or analytical column) 108, and a detector 112. The GC inlet device 104 and GC column 108 may be enclosed in a housing 116. The GC 100 may further include a sample introduction device (or sample injector) 120, a sample source 124, a carrier gas source 128, and a heating device 132.

The GC column 108 may have any configuration now known or later developed. The GC column 108 includes an appropriate stationary phase. As illustrated, a portion of the GC column 108 may be coiled to accommodate a desired length while minimizing the size of the housing 108.

The detector 112 may any detector suitable for detecting peaks eluting from the GC column 108. Examples of detectors include, but are not limited to, flame ionization detectors (FID), thermal conductivity detectors (TCD), electron capture detectors (ECD), flame thermionic detectors (FTD), flame photometric detectors (FPD), etc. Generally, a wide variety of detectors may be utilized, and the illustrated detector 112 may represent a combination of two or more different types of detectors. In some embodiments, the detector 112 is, or is part of, an analytical instrument such as, for example, a mass spectrometer (MS), an ion mobility spectrometer (IMS), etc. Thus, in some embodiments, the GC system 100 may be a hyphenated system such as a GC-MS or GC-IMS system. The detector 112 may also be schematically representative of a data acquisition system, display/readout device, and other components associated with generating chromatograms and spectra as appreciated by persons skilled in the art.

The heating device 132 may have any configuration suitable for maintaining the GC column 108 at a desired temperature setting or for varying the temperature of the GC column 108 according to a desired (predetermined) temperature profile, such as for balancing parameters such as elution time and measurement resolution. In some embodiments, the housing 116 is or includes a temperature-programmable GC oven, and the heating device 132 is configured for heating the interior of the oven through which the GC column 108 extends. In other embodiments, the heating device 132 is configured for heating the GC column 108 directly. For example, the heating device 132 may include a resistive heating element mounted in thermal contact with the GC column 108.

The sample introduction device 120 may be any device configured for injecting a sample into the GC inlet device 104. Sample injection may be carried out on an automated, semi-automated or manual basis. The sample introduction device 120 may, for example, include a manually operated syringe or a syringe that is part of an automated sampling apparatus (or “autosampler”). The sample source 124 may be located upstream of the sample introduction device 120, or may be one or more sample containers (as illustrated) provided at the sample introduction device 120. In the latter case, the sample containers may be loaded on a carousel or other device that selects a desired sample for injection into the GC column 108.

The carrier gas source 128 supplies a carrier gas to the GC inlet device 104 via a carrier gas line 136 at a regulated flow rate and/or pressure. The carrier gas may be any gas suitable for serving as an inert mobile phase that facilitates transport of the sample through the GC column 108 as appreciated by persons skilled in the art. Examples of carrier gases include, but are not limited to, helium, nitrogen, argon, and hydrogen. The GC inlet device 104 introduces the sample flow into the carrier gas flow, and processes the mixture in a manner described below. The GC inlet device 104 may be located in the housing (oven) 116, in which case it may be enclosed in a thermally insulating cup.

FIG. 2 is a schematic elevation view of an example of a GC inlet device 204 according to some embodiments. The GC inlet device 204 generally includes an inlet chamber 250, a liner chamber (or liner column, or liner) 254, a multi-capillary liner (MCL) 256 disposed in the liner chamber 254, and an outlet chamber 260. The GC inlet device 204 may also include a temperature control device 264.

The inlet chamber 250 includes a sample inlet 268 configured for communicating with a sample introduction device. In some embodiments, the sample inlet 268 includes a septum or other closure member for receiving a needle 270 of the sample introduction device. The inlet chamber 250 also includes a (first) carrier gas inlet 272 configured for communicating with a (first) carrier gas line. The inlet chamber 250 may also include a (first) purge outlet 274 configured for purging gas to a (first) purge vent 276.

The outlet chamber 260 includes an outlet port 278 configured for communicating with a GC column. The outlet chamber 260 may also include a (second) carrier gas inlet 280 configured for communicating with a (second) carrier gas line. The outlet chamber 260 may also include a (second) purge outlet 282 configured for purging gas to a (second) purge vent 284. In some embodiments, the outlet chamber 260 is extended around all or a portion of the axial length of the liner chamber 254. That is, the outlet chamber 260 may include an annular section 286 coaxially surrounding the liner chamber 254. In some embodiments, the inlet chamber 250 and outlet chamber 260 are formed from a cylindrical structure and separated by a sealing element, such as an o-ring 288 surrounding the liner chamber 254, as illustrated.

The temperature control device 264 may include a heating device 206 which, by example, is shown is coaxially surrounding the inlet chamber 250, liner chamber 254, and outlet chamber 260. In some embodiments, the heating device 206 is configured for heating the inlet chamber 250 to vaporize sample material upstream of the liner chamber 254. In other embodiments, the heating device 206 is configured for also heating the liner chamber 254 and MCL 256. The heating device 206 may be configured for providing a temperature gradient along the axial length of the GC inlet device 204. In some embodiments, the heating device 206 may include one or more heating zones 210. Distinct heating zones 210 may facilitate establishing a temperature gradient, or for heating one or more selected regions of the liner chamber 254. In some embodiments, one or more of the heating zones 210 may be independently controlled to maintain different temperature settings along the length of the GC inlet device 204. For example, the uppermost heating zone 210 in closest thermal contact with the inlet chamber 254 may provide the highest temperature for vaporizing the sample, while one or more lower heating zones 210 may maintain the MCL 256 at lower temperatures designed to optimize chromatography with the most volatile early eluters. Each heating zone 210 may schematically represent a heating component such as, for example, an electrically resistive heating element or a chamber through which a heat transfer medium (gas or liquid) is routed.

In some embodiments, the inlet chamber 250 and corresponding heating zone 210 may be part of a separate, upstream device (a vaporizing device, or vaporizer), in which case vaporized sample material and carrier gas may flow from an outlet of the upstream device to an inlet leading to the liner chamber 254. Providing an upstream vaporizing device may facilitate optimizing the vaporization and pre-GC column separation processes.

In some embodiments, the temperature control device 264 may also include a cooling device 222. The cooling device 222 may include a cooling jacket 226 for routing a heat transfer medium (gas or liquid) from an inlet 230 to an outlet 234 which, it will be understood, have been arbitrarily located in FIG. 2 by schematic example. By example, the cooling jacket 226 is shown as coaxially surrounding the inlet chamber 250, liner chamber 254, and outlet chamber 260.

The MCL 256 includes a parallel array or bundle of small-bore tubes, or capillaries 238, as further shown in FIG. 3, which is a cross-sectional view of the liner chamber 254 and MCL 256. Each capillary 238 is parallel to the axis of the GC inlet device 204 and thus parallel with the general direction of sample-gas flow through the GC inlet device 204. The capillaries 238 are packed together so as to span the entire cross-section of the liner chamber 254. The MCL 256 thus divides the sample-gas flow through the liner chamber 254 into a plurality of parallel flow paths. The liner chamber 254 and capillaries 238 may be composed of, for example, quartz or any other material suitable for use as a GC inlet liner or GC column. In some embodiments, the inside walls of the capillaries 238 are coated with a material that acts as a stationary phase such as, for example, polydimethylsiloxane (PDMS)-based polymers (e.g., OV-5, and others). Other phase coatings utilized in GC columns may also be utilized in the capillaries 238 of the MCL 256 disclosed herein. The number of capillaries 238 depends on their size and the size of the liner chamber 254, and may be on the order of tens, hundreds, or thousands. As examples, the liner chamber 254 may have an inside diameter and a length ranging on the order of millimeters, and the capillaries 238 may have an inside diameter on the order of micrometers and a length on the order of millimeters. As a few specific examples, the liner chamber 254 may have an inside diameter of 4 mm, and the capillaries 238 may have an inside diameter of 0.53 mm, 0.32 mm, 0.1 mm, or 0.05 mm and a length of 150 mm. In another specific example, 1200 capillaries 238 having a an inside diameter of 0.06 mm a length of 150 mm may be packed in a liner chamber 254 having an inside diameter of 4 mm.

Testing of examples of a GC inlet device that included the MCL 256 with open interstices has demonstrated significantly improved chromatographic separation performance over GC inlet devices equipped with conventional liners such as liners containing packed beads. However, FIG. 3 shows that bundling capillaries 238 of circular cross-section together inside a liner chamber 254 of circular cross-section results in interstices between neighboring capillaries 238 and between outer capillaries 238 and the inside wall of the liner chamber 254. The sizes (cross-sectional flow areas) of these interstices depend on the sizes of the capillaries 238. The interstices create a parallel bypass flow through the MCL 256—that is, a portion of sample-gas mixture flows through the interstices instead of the interiors of the capillaries 238, thus avoiding contact with the stationary phase. As a result, the MCL 256 with open interstices has an inherent “split” flow that is based on the ratio of the flow resistance through the capillaries 238 to the flow resistance through the interstices, which ratio depends on the size of the capillaries 238.

Although the MCL 256 with open interstices offers superior separation performance, the bypass flow through the interstices may affect performance in some applications. The sizes of the interstices may be minimized by bundling the capillaries 238 in a closely packed arrangement such as a hexagonal array (honeycomb), as illustrated in FIG. 3. Additionally, in some embodiments and as illustrated, the MCL 256 may include a filler material 340 that fills and seals the interstices, thereby blocking fluid flow through the interstices (i.e, eliminating bypass flow). Any filler material 340 suitable for this purpose, and which may be effectively applied so as to completely fill in the interstices (e.g., an initially flowable or pliable/malleable material that is thereafter settable or curable) may be utilized, one non-limiting example being epoxy. Testing of examples of a GC inlet device that included the MCL 256 with filled-in interstices has demonstrated further improvements in chromatographic separation performance over known GC inlet devices.

FIGS. 4A to 4D are schematic elevation views the GC inlet device 204 similar to FIG. 2, illustrating examples of a flow control system and also illustrating some examples of different modes of operation provided by the GC inlet device 204 according to some embodiments. For simplicity, temperature control components are not shown. The flow control system may include conduits (or “lines”) for directing carrier gas into the GC inlet device 204, directing sample-carrier gas mixtures into the analytical GC column, and directing (venting) gases and vapors out from the GC inlet device 204 instead of injecting them into the GC column. The flow control system may also include one or more flow control devices (or flow controllers) positioned at one or more conduits and configured for controlling flow rates and/or pressures in the conduits and/or interior regions of the GC inlet device 204. Generally, a variety of different devices and plumbing configurations may be utilized to control flow paths, flow rates and pressures in the GC inlet device 204.

In the illustrated embodiment, the GC inlet device 204 includes a carrier gas line, which in some embodiments is split into a first carrier gas line 472 and a second carrier gas line 480. The carrier gas lines 472 and 480 terminate at or are coupled to the carrier gas inlets 272 and 280 described above in conjunction with FIG. 2. The GC inlet device 204 may also include one or more purge lines, such as a first purge line 474 (or septum purge line) and a second purge line 482 (or split purge line), which provide respective flow paths from the first purge outlet 274 to the first purge vent 276 and the second purge outlet 282 to the second purge vent 284, shown in FIG. 2. FIGS. 4A to 4E also show the outlet port 278 in fluid communication with a GC column 408.

In the illustrated embodiment, the GC inlet device 204 further includes respective mass flow controllers (MFC) 490 and 492 operatively located on the carrier gas lines 472 and 480, a forward pressure controller (FPC) 494 operatively located on the first purge line 474, and a back pressure controller (BPC) 496 operatively located on the second purge line 482. A fit 498 or other flow restricting component may also be located on the first purge line 474. Other components that may be provided may include valves for regulating flow rate, switchable valves for selecting flow paths, flow meters, pressure transducers, tee-connections or unions for splitting or merging flow paths, etc., all as understood by persons skilled in the art. It is also understood that flow and pressure controllers may be controlled by an appropriately configured system controller (electronic hardware, firmware, software, etc.) that may be provided with the GC system in which the GC inlet device 204 operates.

As noted earlier in this disclosure, it is desirable to achieve a sufficient degree of separation in a GC inlet device to allow the inlet to selectively pass analytes of interest to the GC column while minimizing loss of analytes (and ideally without any loss of analyte). This may be addressed by splitting away unwanted solvent, or preventing late eluting components that are less volatile than the analytes from being transferred to the GC column. This latter ability to have the inlet selectively discriminate against later eluting, low volatility compounds is of special interest for protecting the GC column from accumulating contamination from poorly volatile material present in the sample matrix. This is also of particular interest when employing comparatively expensive column types such as low thermal mass column assemblies in conjunction with samples known to have complex matrices that are rich in such contaminating materials.

The GC inlet device 204 with the MCL 256 as disclosed herein is operable to achieve a high degree of separation so that eluting compounds may be selectively split or cut from the sequence of compounds eluting from the GC inlet device 204 to the GC column. The GC inlet device 204 is operable to allow analytes of interest to pass directly to the GC column without discrimination, and to reject components not of interest. For example, the GC inlet device 204 may be operated to reject early eluting solvent (such as be operating in a split mode as described below), thereby sparing the GC column and detector from the large quantity of solvent typically present as compared to the quantity of analytes. Rejection of early eluters may be followed by passing the analytes of interest to the GC column (such as by switching to a splitless mode as described below), during which time analytes may be subjected to pre-column separation activity in the MCL 256. After transferring the last analytes of interest, the GC inlet device 204 may be operated to reject late eluting components by splitting or backflush flow. The ability to reject late eluters may facilitate the direct integration of the GC inlet device 204 with a low thermal mass GC column, and may eliminate the need for a guard column. This may facilitate the design of GC instruments with small footprints and low power requirements which, for example, are considerations for designing transportable and portable instruments. En addition, the effectiveness of the MCL 256 in separating components may enable selecting only a limited range of analytes from the sample injected into the GC inlet device 204 to thereafter pass on to the GC column (e.g., “heart cutting”).

FIGS. 4A to 4D will now be referred to in conjunction with describing some examples of different modes of operation capable of being implemented by the GC inlet device 204 according to some embodiments. The descriptions of different modes of operation are followed by examples of specific flow conditions. Each specific example assumes that a 10 psig GC column head pressure creates a target flow 442 into the GC column of 2 mL/min, and that fit flow 444 is calibrated as 3 mL/min at 0.3 psig and 10 mL/min at 0.5 psig. Generally, the GC inlet device 204 is capable of implementing splitless, split, backflush, and “cut” modes. The flow control system is adapted to select different modes and switch the GC inlet device 204 between different modes as needed for a particular application.

FIG. 4A illustrates the GC inlet device 204 operating in a normal splitless injection mode. A flow 446 of carrier gas into the inlet chamber 250 is established and via the first carrier gas line 472, and analyte-containing sample is injected into the inlet chamber 250 through the sample inlet 268. The sample is vaporized in the inlet chamber 250 and is entrained in the carrier gas flow. The sample-gas mixture flows through the liner chamber 254 and through the capillaries 238 of the MCL 256 where chromatographic separation occurs. From the liner chamber 254, the sample-gas mixture flows into the outlet chamber 260, through the outlet port 278, and into the GC column 408. The second purge line 482 (if provided) is closed during the splitless mode. Optionally, the first purge line 474 is provided and is open during this mode to purge the inlet chamber 250 such that a portion of the flow 444 of the sample-gas mixture is vented from the GC inlet device 204, which may prevent ghosting as appreciated by persons skilled in the art. Optionally, the second carrier gas line 480 is provided and a small flow 448 of carrier gas (at a lower flow rate than the first carrier gas flow 446) is conducted into the outlet chamber 260 via the second carrier gas line 480 to prevent analytes from diffusing into the second carrier gas line 480.

As one non-limiting example of operating in the splitless mode, the flow of carrier gas 446 through the first carrier gas line 472 may be 4.5 mL/min and the flow 444 of sample-gas mixture through the first purge line 474 may be 3 mL/min (resulting in a flow of 1.5 mL/min through the MCL 256), and the flow 448 of carrier gas through the second carrier gas line 480 may be 0.5 mL/min, resulting in a flow 442 of sample-gas mixture into the GC column 408 of 2 mL/min.

FIG. 4B illustrates the GC inlet device 204 operating in a normal split injection mode. A flow 446 of carrier gas into the inlet chamber 250 is established and a sample is injected into the inlet chamber 250 through the sample inlet 268. In this mode, the second purge line 482 is open, so a portion of the sample-gas mixture flows from the outlet chamber 260 to second purge line 482 (flow 450) and is vented from the GC inlet device 204. Optionally, the first purge line 474 is provided and is open during this mode to purge the inlet chamber 250 (flow 444). Optionally, the second carrier gas line 480 is provided and a small flow 448 of carrier gas is conducted into the outlet chamber 260 via the second carrier gas line 480 to keep the second carrier gas line 480 purged of analytes. The flow control system may adjust the GC inlet device 204 to any desired split ratio (ratio of column flow rate to split vent flow rate). In the typical case, the flow rate through the MCL 256 during the split mode is significantly higher than during the splitless mode.

As one non-limiting example of operating in the split mode, the split ratio is set to 20:1. The flow 446 of carrier gas through the first carrier gas line 472 may be 33 mL/min and the flow 444 of sample-gas mixture through the first purge line 474 may be 3 mL/min, resulting in a flow of 30 mL/min through the MCL 256. The flow 448 of carrier gas through the second carrier gas line 480 may be 0.5 mL/min, and the flow 450 of sample-gas mixture through the second purge line 482 may be 28.5 mL/min, resulting in a flow 442 of sample-gas mixture into the GC column 408 of 2 mL/min.

FIG. 4C illustrates the GC inlet device 204 operating in a backflush mode. In this mode, a flow 448 of carrier gas is conducted into the outlet chamber 260 via the second carrier gas line 480, through the liner chamber 254 (including the MCL 256) and into the inlet chamber 250. During this reverse flow, the carrier gas entrains or sweeps media residing in the outlet chamber 260, liner chamber 254 and inlet chamber 250. The mixture is then vented from the GC inlet device 204 via the first purge line 474 (flow 444). Optionally, a small flow 446 of carrier gas is conducted into the inlet chamber 250 via the first carrier gas line 472 as a purge flow. Optionally, the second purge line 482 is open, so a portion of the carrier gas mixture is vented via the second purge line 482 (flow 450) to purge analytes from the split flow path. The backflush mode may be implemented during sample injection to truncate the elution at a desired time to eliminate selected sample components from the sequence injected into the GC column 408. The backflush mode may also be implemented between sample injection events for purposes such as flushing or purging the GC inlet device 204.

As one non-limiting example of operating in the backflush mode, the flow 448 of carrier gas through the second carrier gas line 480 may be 15 mL/min, the flow 450 of gas through the second purge line 482 may be 4 mL/min, and the flow 442 of gas mixture into the GC column 408 may be 2 mL/min, resulting in a back flow of 9 mL/min through the MCL 256. The flow 446 of carrier gas through the first carrier gas line 472 may be 1 mL/min, resulting in a flow 444 of mixture through the first purge line 474 of 10 mL/min.

FIG. 4D illustrates the GC inlet device 204 operating in a cut mode, which may be implemented during splitless injection (a cut/splitless injection mode) or split injection (a cut/split injection mode). A sample is injected into the inlet chamber 250 through the sample inlet 268. In the cut mode, the second purge line 482 is open, carrier gas is conducted from the first carrier gas line 472 into the inlet chamber 250, and carrier gas is conducted from the second carrier gas line 480 into the outlet chamber 260. The flow conditions are set such that all flow from the MCL 256 is diverted away from the GC column 408 such that only carrier gas from flow 448 flows into the GC column 408. In the cut/split mode, the flow from the MCL 256 is diverted to the second purge line 482, and optionally the first purge line 474 is also open. In the cut/splitless mode, one or both of the first purge line 474 and second purge line 482 are open.

As one non-limiting example of operating in the cut/splitless injection mode, the flow of carrier gas 446 through the first carrier gas line 472 may be 4.5 mL/min, the flow 448 of carrier gas through the second carrier gas line 480 may be 3 mL/min, the flow 444 of sample-gas mixture through the first purge line 474 may be 3 mL/min, and the flow 450 of sample-gas mixture through the second purge line 482 may be 2.5 mL/min. This results in a net flow of 1.5 mL/min through the MCL 256 and a flow 442 of carrier gas into the GC column 408 of 2 mL/min.

As one non-limiting example of operating in the cut/split injection mode, the split ratio is set to 20:1. The flow of carrier gas 446 through the first carrier gas line 472 may be 33 mL/min, the flow 448 of carrier gas through the second carrier gas line 480 may be 3 mL/min, the flow 444 of sample-gas mixture through the first purge line 474 may be 3 mL/min, and the flow 450 of sample-gas mixture through the second purge line 482 may be 31 mL/min. This results in a net flow of 30 mL/min through the MCL 256 and a flow 442 of carrier gas into the GC column 408 of 2 mL/min.

The cut mode may be utilized when complete rejection of solvent or analyte components is desired, or when rejection is desired at lower flow rates. Generally, the split mode during normal injection does not eliminate solvent or components but rather attenuates them by the split ratio. In the case of the solvent, this can still amount to a large quantity of material being transferred to the GC column 408 after splitting. Moreover, the split mode during normal injection typically entails a large increase in flow rate through the liner column 254 that may lead to undesirable shifts in retention. If multiple splitting events are contemplated in a single chromatogram, the required timing of events becomes more empirical rather than being simple and self-evident based on the elution times in the initial chromatogram. For these reasons, there are situations in which it is more ideal to implement the above-described cut mode, in which elutions are unchanged and the components may be individually and quantitatively transferred to the GC column 408 and detector or rejected to the cut pathway.

FIGS. 5A to 5D are chromatograms produced by a GC system in which the GC inlet device included an MCL as described above. The sample was a test mixture of C₁₂-C₁₉ hydrocarbons.

FIG. 5A illustrates implementation of the cut mode to remove solvent. The cut mode was applied with a 1:1 split ratio for the first two minutes of sample injection into the GC inlet device. Only a small amount of a solvent tail remained for transfer into the GC column. The damped oscillation superposed on the solvent tail resulted from a minor oscillation in the pneumatics of the flow control system. FIG. 5A demonstrates a drastic and highly successful reduction of solvent transfer from the GC inlet device. There did not appear to be any analyte loss in this process.

FIG. 5B illustrates implementation of the cut mode from 8.0 to 8.8 minutes to eliminate the C₁₄ component. This was achieved without analyte losses or retention shifts.

FIG. 5C illustrates implementation of the backflush mode at 9.5 minutes to eliminate the C₁₉ component.

FIG. 5D illustrates how extending the cut mode and combining it with the backflush mode may be utilized to eliminate all of the peaks preceding and succeeding a peak of choice. Chromatogram A is the 1:1 split analysis, showing peaks for all four components of the test mixture. Chromatogram B illustrates applying the cut mode from 0 to 8 minutes, and then applying the backflush mode from 8.8 minutes onward. This resulted in the C₁₄ component being the only component transferred from the GC inlet device. Similarly, chromatogram C illustrates applying the cut mode from 0 to 8.8 minutes, and then back flushing from 9.6 minutes onward. This resulted in only the C₁₆ component being transferred. Chromatogram D shows the result of applying a cut for 10.5 minutes followed by 1:1 split operation for the duration of the chromatogram. Chromatogram D shows that the baseline beyond the C₁₉ peak appears normal following an extended cut through most of the chromatogram. The results in FIG. 5D demonstrate a near preservation of the elution times without analyte loss. The implementation of combinations of cuts and back flushes are simple due to the constancy of the flow rate through the liner. The parameters for complex cuts and back flushes may be determined from a single examination of the original chromatogram.

FIG. 6 is a schematic view of an example of a GC inlet assembly 600 according to some embodiments. The GC inlet assembly 600 may include a vaporization device 604 fluidly communicating with the GC inlet device 204. The vaporization device 604 may include a vaporization chamber 608 and a heater 612 in thermal contact with the vaporization chamber 608. The vaporization chamber 608 includes a sample inlet 616 configured for communicating with a sample introduction device. In some embodiments, the sample inlet 616 includes a septum or other closure member for receiving a needle of the sample introduction device. The vaporization chamber 608 also includes a carrier gas inlet 620 configured for communicating with a carrier gas line. The vaporization chamber 608 may also include a purge outlet 624 configured for purging gas to a purge vent. In some embodiments, the vaporization device 604 may also include a split flow path from the vaporization chamber 608 a split vent, in a manner analogous to that described above in relation to embodiments of the GC inlet device 204. The vaporization chamber 608 also includes an outlet port 628. The sample is vaporized by the heater 612, and the sample-carrier gas mixture flows through the outlet port 628, through a transfer line 632, and into the inlet chamber of the GC inlet device 204.

The GC inlet device 204 of the GC inlet assembly 600 may generally be configured as described above. For example, the GC inlet device 204 may be operated in (and switchable between) the above-described splitless, split, backflush and cut modes. The GC inlet device 204 may also be configured for temperature control, such as for establishing a temperature gradient or controlling the temperature of individual zones, as described above. Additionally, the GC inlet device 204 may include an MCL as described above for performing separations prior to injecting the sample-carrier gas mixture into the GC column 408. In some applications, the provision of a separate vaporization device 504 may facilitate optimizing the desired operation of the GC inlet device 204 by decoupling the primary vaporization function from the GC inlet device 204. It will be understood that one or more features of the above-described GC inlet device 204 may be eliminated if they are duplicative of features provided by the vaporization device 604.

### Exemplary Embodiments

Exemplary embodiments provided in accordance with the presently disclosed subject matter include, but are not limited to, the following:

1. A gas chromatograph (GC) inlet device, comprising: an inlet chamber; a sample inlet communicating with the inlet chamber; a carrier gas inlet communicating with the inlet chamber; a liner chamber comprising a first end communicating with the inlet chamber and an axially opposing second end; a plurality of parallel capillaries disposed in the liner chamber; an outlet chamber communicating with the second end; and an outlet port communicating with the outlet chamber for coupling with a GC column.

2. The GC inlet device of embodiment 1, comprising a filler material occupying interstices between the capillaries, wherein the filler material prevents fluid flow between the capillaries.

3. The GC inlet device of embodiment 1 or 2, wherein the capillaries comprise a stationary phase disposed in interiors of the capillaries.

4. The GC inlet device of any of embodiments 1-3, comprising a temperature controller configured for controlling temperature at one or more regions of the GC inlet device.

5. The GC inlet device of embodiment 4, wherein the temperature controller comprises a multi-zone heater configured for independently heating different zones along a length of the GC inlet device.

6. The GC inlet device of embodiment 4, wherein the temperature controller is configured for independently controlling a temperature of the inlet chamber and a temperature of the liner chamber.

7. The GC inlet device of any of embodiments 1-6, wherein the carrier gas inlet is a first carrier gas inlet, and further comprising a second carrier gas inlet communicating with the outlet chamber.

8. The GC inlet device of any of embodiments 1-7, comprising a first purge outlet communicating with the inlet chamber, a second purge outlet communicating with the outlet chamber, or both a first purge outlet and a second purge outlet.

9. The GC inlet device of any of embodiments 1-8, comprising a flow control system switchable between two or more modes of operation selected from the group consisting of a normal injection mode, a normal splitless mode, a normal split mode, a backflush mode, a cut mode, a cut splitless mode, and a cut split mode.

10. The GC inlet device of any of embodiments 1-9, comprising a purge vent communicating with the outlet chamber, and a flow control system switchable between a splitless mode and a split mode, wherein at the splitless mode fluid flowing from the liner chamber is prevented from flowing to the split vent, and at the split mode at least some of the fluid flowing from the liner chamber flows to the split vent.

11. The GC inlet device of any of embodiments 1-10, wherein the carrier gas inlet is a first carrier gas inlet, and further comprising a second carrier gas inlet communicating with the outlet chamber, a purge vent communicating with the inlet chamber, and a flow control system switchable between a normal injection mode and a backflush mode, wherein: at the normal injection mode the flow of carrier gas through the first carrier gas inlet is higher than the flow of carrier gas through the second carrier gas inlet; and at the backflush mode the flow of carrier gas through the second carrier gas inlet is higher than the flow of carrier gas through the first carrier gas inlet, and a net flow of carrier gas is directed from the outlet chamber, through the liner chamber, through the inlet chamber, and to the purge vent.

12. The GC inlet device of any of embodiments 1-11, wherein the carrier gas inlet is a first carrier gas inlet, and further comprising a second carrier gas inlet communicating with the outlet chamber, a purge vent communicating with the outlet chamber, and a flow control system switchable between a normal injection mode and a cut mode, wherein: at the normal injection mode the flow control system adjusts respective flows of carrier gas through the first carrier gas inlet and the second carrier gas inlet such that a substantial portion of fluid flowing through the liner chamber flows through the outlet port; and at the cut mode the flow control system adjusts the respective flows such that substantially all of the fluid flowing through the liner chamber is diverted away from the outlet port and directed to the purge vent.

13. A gas chromatograph (GC), comprising: the GC inlet device of any of embodiments 1-12; and a GC column communicating with the outlet port.

14. A gas chromatograph (GC) inlet assembly, comprising: a vaporization device comprising: a vaporization chamber; a carrier gas inlet communicating with the vaporization chamber; a heater configured for heating the vaporization chamber; and a first outlet port communicating with the vaporization chamber; and a GC inlet device comprising: an inlet chamber communicating with the first outlet port; a sample inlet communicating with the inlet chamber; a liner chamber comprising a first end communicating with the inlet chamber and an axially opposing second end; a plurality of parallel capillaries disposed in the liner chamber; an outlet chamber communicating with the second end; and a second outlet port communicating with the outlet chamber for coupling with a GC column.

15. A method for introducing a sample to a gas chromatograph (GC) chamber, the method comprising: flowing a sample and a carrier gas through a liner chamber; separating components of the sample by flowing the sample through a plurality of parallel capillaries disposed in the liner chamber; and flowing the sample from the liner chamber to the GC column.

16. The method of embodiment 15, comprising vaporizing the sample before flowing the sample to the GC column.

17. The method of embodiment 15 or 16, comprising heating the sample before flowing the sample to the GC column according to a mode selected from the group consisting of: heating an inlet chamber from which the sample flows to the liner chamber; heating the liner chamber; heating an inlet chamber from which the sample flows to the liner chamber, and heating the liner chamber at a different temperature than the inlet chamber; heating two or more zones along a length of the liner chamber at different temperatures; and a combination of two or more of the foregoing.

18. The method of any of embodiments 15-17, comprising controlling a temperature of the capillaries, and controlling a temperature of a zone upstream of the capillaries such that the capillaries are maintained at a lower temperature than the upstream zone.

19. The method of any of embodiments 15-18, comprising conducting a first flow of the carrier gas into an inlet chamber upstream of the liner chamber, and conducting a second flow of the carrier gas into an outlet downstream of the liner chamber.

20. The method of any of embodiments 15-19, comprising flowing at least a portion of the sample from the liner chamber through a purge vent.

21. The method of any of embodiments 15-20, comprising switching between a split mode and a splitless mode, wherein the split mode comprises flowing at least a portion of the sample from the liner chamber into an outlet chamber, and through a purge vent instead of to the GC column, and the splitless mode comprises flowing the sample through the outlet chamber and to the GC column without flowing the sample through the purge vent.

22. The method of any of embodiments 15-21, comprising switching between a normal flow mode and a back flush mode, wherein the normal flow mode comprises flowing the carrier gas to an inlet chamber, through the liner chamber and to an outlet chamber, and the back flush mode comprises flowing the carrier gas directly to the outlet chamber such that the sample eluting from the liner chamber is diverted to a purge valve.

23. The method of any of embodiments 15-22, comprising switching between a normal flow mode and a cut mode, wherein the normal flow mode comprises flowing the carrier gas to an inlet chamber, through the liner chamber and to an outlet chamber, and the cut mode comprises flowing the carrier gas to the inlet chamber and to the outlet chamber such that the sample eluting from the liner is diverted to a purge valve.

24. The method of any of embodiments 15-23, comprising, before flowing the sample and the carrier gas through the liner chamber, flowing the sample and the carrier gas through a vaporization device.

25. A gas chromatograph (GC) inlet device configured for performing the method of any of embodiments 15-24.

It will be understood that terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A gas chromatograph (GC) inlet device, comprising:
an inlet chamber;
a sample inlet communicating with the inlet chamber;
a carrier gas inlet communicating with the inlet chamber;
a liner chamber comprising a first end communicating with the inlet chamber and an axially opposing second end;
a plurality of parallel capillaries disposed in the liner chamber;
an outlet chamber communicating with the second end; and
an outlet port communicating with the outlet chamber for coupling with a GC column.

2. The GC inlet device of claim 1, comprising a filler material occupying interstices between the capillaries, wherein the filler material prevents fluid flow between the capillaries.

3. The GC inlet device of claim 1, wherein the capillaries comprise a stationary phase disposed in interiors of the capillaries.

4. The GC inlet device of claim 1, comprising a temperature controller selected from the group consisting of: a temperature controller configured for controlling temperature at one or more regions of the GC inlet device, a temperature controller comprising a multi-zone heater configured for independently heating different zones along a length of the GC inlet device; and a temperature controller configured for independently controlling a temperature of the inlet chamber and a temperature of the liner chamber.

5. The GC inlet device of claim 1, wherein the carrier gas inlet is a first carrier gas inlet, and further comprising a second carrier gas inlet communicating with the outlet chamber.

6. The GC inlet device of claim 1, comprising a first purge outlet communicating with the inlet chamber, a second purge outlet communicating with the outlet chamber, or both a first purge outlet and a second purge outlet.

7. The GC inlet device of claim 1, comprising a flow control system switchable between two or more modes of operation selected from the group consisting of a normal injection mode, a normal splitless mode, a normal split mode, a backflush mode, a cut mode, a cut splitless mode, and a cut split mode.

8. The GC inlet device of claim 1, comprising a purge vent communicating with the outlet chamber, and a flow control system switchable between a splitless mode and a split mode, wherein at the splitless mode fluid flowing from the liner chamber is prevented from flowing to the split vent, and at the split mode at least some of the fluid flowing from the liner chamber flows to the split vent.

9. The GC inlet device of claim 1, wherein the carrier gas inlet is a first carrier gas inlet, and further comprising a second carrier gas inlet communicating with the outlet chamber, a purge vent communicating with the inlet chamber, and a flow control system switchable between a normal injection mode and a backflush mode, wherein:
at the normal injection mode the flow of carrier gas through the first carrier gas inlet is higher than the flow of carrier gas through the second carrier gas inlet; and
at the backflush mode the flow of carrier gas through the second carrier gas inlet is higher than the flow of carrier gas through the first carrier gas inlet, and a net flow of carrier gas is directed from the outlet chamber, through the liner chamber, through the inlet chamber, and to the purge vent.

10. The GC inlet device of claim 1, wherein the carrier gas inlet is a first carrier gas inlet, and further comprising a second carrier gas inlet communicating with the outlet chamber, a purge vent communicating with the outlet chamber, and a flow control system switchable between a normal injection mode and a cut mode, wherein:
at the normal injection mode the flow control system adjusts respective flows of carrier gas through the first carrier gas inlet and the second carrier gas inlet such that a substantial portion of fluid flowing through the liner chamber flows through the outlet port; and
at the cut mode the flow control system adjusts the respective flows such that substantially all of the fluid flowing through the liner chamber is diverted away from the outlet port and directed to the purge vent.

11. A gas chromatograph (GC), comprising:
the GC inlet device of claim 1; and
a GC column communicating with the outlet port.

12. A gas chromatograph (GC) inlet assembly, comprising:
a vaporization device comprising:
a vaporization chamber;
a carrier gas inlet communicating with the vaporization chamber;
a heater configured for heating the vaporization chamber; and
a first outlet port communicating with the vaporization chamber; and
a GC inlet device comprising:
an inlet chamber communicating with the first outlet port;
a sample inlet communicating with the inlet chamber;
a liner chamber comprising a first end communicating with the inlet chamber and an axially opposing second end;
a plurality of parallel capillaries disposed in the liner chamber;
an outlet chamber communicating with the second end; and
a second outlet port communicating with the outlet chamber for coupling with a GC column.

13. A method for introducing a sample to a gas chromatograph (GC) chamber, the method comprising:
flowing a sample and a carrier gas through a liner chamber;
separating components of the sample by flowing the sample through a plurality of parallel capillaries disposed in the liner chamber; and
flowing the sample from the liner chamber to the GC column.

14. The method of claim 13, comprising heating the sample before flowing the sample to the GC column according to a mode selected from the group consisting of: vaporizing the sample before flowing the sample to the GC column; heating an inlet chamber from which the sample flows to the liner chamber; heating the liner chamber; heating an inlet chamber from which the sample flows to the liner chamber, and heating the liner chamber at a different temperature than the inlet chamber; heating two or more zones along a length of the liner chamber at different temperatures; controlling a temperature of the capillaries, and controlling a temperature of a zone upstream of the capillaries such that the capillaries are maintained at a lower temperature than the upstream zone; and a combination of two or more of the foregoing.

15. The method of claim 13, comprising conducting a first flow of the carrier gas into an inlet chamber upstream of the liner chamber, and conducting a second flow of the carrier gas into an outlet downstream of the liner chamber.

16. The method of claim 13, comprising flowing at least a portion of the sample from the liner chamber through a purge vent.

17. The method of claim 13, comprising switching between a split mode and a splitless mode, wherein the split mode comprises flowing at least a portion of the sample from the liner chamber into an outlet chamber, and through a purge vent instead of to the GC column, and the splitless mode comprises flowing the sample through the outlet chamber and to the GC column without flowing the sample through the purge vent.

18. The method of claim 13, comprising switching between a normal flow mode and a back flush mode, wherein the normal flow mode comprises flowing the carrier gas to an inlet chamber, through the liner chamber and to an outlet chamber, and the back flush mode comprises flowing the carrier gas directly to the outlet chamber such that the sample eluting from the liner chamber is diverted to a purge valve.

19. The method of claim 13, comprising switching between a normal flow mode and a cut mode, wherein the normal flow mode comprises flowing the carrier gas to an inlet chamber, through the liner chamber and to an outlet chamber, and the cut mode comprises flowing the carrier gas to the inlet chamber and to the outlet chamber such that the sample eluting from the liner is diverted to a purge valve.

20. The method of claim 13, comprising, before flowing the sample and the carrier gas through the liner chamber, flowing the sample and the carrier gas through a vaporization device.
